(19) United States
(12) Patent Application Publication
(10) Pub. No.: US 2020/0187606 A1
(43) Pub. Date: Jun. 18, 2020

(54) A GEMSTONE WITH A HEART SHAPE AT THE CENTRE AND ITS METHOD OF MANUFACTURE

(71) Applicant: BLUE STAR DIAMONDS PVT. LTD., Mumbai, Maharashtra (IN)

(72) Inventor: Arun Kumar Shekhawat, Surat Gujarat (IN)

(21) Appl. No.: 16/607,669

(22) PCT Filed: Apr. 3, 2018
(86) PCT No.: PCT/IN2018/050187

§ 371 Date: Oct. 23, 2019

(30) Foreign Application Priority Data
Apr. 24, 2017 (IN) 201723014425

(51) Int. Cl. A44C 17/00; B44B 3/00

(52) U.S. Cl. CPC A44C 17/001; B44B 3/008; A44C 17/007

(57) ABSTRACT

The invention discloses a round or a heart shaped gemstone (FIG. 1) (FIG. 8) visually encompassing a heart shape (FIG. 7,15:AD) within, and its method of manufacture. The gemstone comprises of an upper double crown table facet (A), a lower pavilion (C) with a culet (D) at its lower tip, and a girdle (B) separating the upper crown table facet from the pavilion. The pavilion (FIG. 1) comprises of pavilion main facets, lower girdle facets and short half facets. The short arms (P) of the kite shaped pavilion main facets meet at the culet, long arms (Q) meet at 1^{st} points (R) and the short arms and long arms of each pavilion main facet meet at 2^{nd} points (S) at specific girdle depths. The lower girdle facets (L) and the respective short half facets (T) are faceted from the lower girdle facets at 1^{st} pavilion angles along a cable (R′) joining the 1^{st} points. The 2^{nd} pavilion short half angles (Z) along a cable joining the 2^{nd} points of the pavilion main facets are less than the 1^{st} pavilion angles. The girdle depth of the 1^{st} point of one pair of symmetrical pavilion main facets is 0.5% to 10% less than the remainder pavilion main facets.

### FIELD OF INVENTION

The invention relates to a field of gemstones and more specifically to round cut and heart shaped gemstones, where in such gemstone encompasses the shape of a heart within its body.

### BACK GROUND

A gemstone quality is usually assessed by its carat value, color, clarity, brilliance, light penetration, cut and shape. In addition to these attributes, a gemstone like a diamond's quality is assessed by its symmetry and reflective quality, which is a result of a diamond's cut which affects and potentially enhances all the mentioned characteristics. The cut on the facets determines how well a diamond “performs,” in other words, how well it reflects light under a variety of lighting conditions and situations, and more importantly how they perform in more natural lighting situations. Round diamonds have all the facets in a tier cut to the same angle, which is close to the ideal in terms of brilliance and dispersion. The sophistication of diamond cutting is able to match the new demands among wealthy customers for more unique diamond forms and hence there are challenges to bring in newer innovations, in respect of cuts, appearance and shapes, that give a novel effect, which are a result of innovative cutting, and which do not compromise on brilliance and dispersion.

U.S. Pat. No. 8,813,519 B2 discloses a modified princess cut diamond and a method of forming a modified princess cut diamond into a symmetrical shape possessing a radiating heart and arrows pattern characteristic of the true hearts and arrows pattern in a round cut diamond. However, these heart and arrow pattern cannot be normally seen by the naked eye, and result from the reflection of the facets and not as a result of calculated facet cuts of the diamond. The cuts as described in the aforesaid patent have been bought about by forming reflecting images in the table facet. Further, the invention disclosed in the afore referred patent does not reveal or disclose an invention, where in the gemstone would give the effect of a heart within a round cut or heart shape, and makes it appear as if a heart shaped gem is placed within the gemstone. The image of a gemstone within a gemstone requires not only mere precision, but innovation in cutting the facets, and the angles of the facets in relation to each other. These depend on the shape of the gemstone, i.e. whether they are round cut, cushion cut, princess cut or heart shape.

The present invention discloses for the first time, a series of facet cuts by which a heart shape design can be seen within a round diamond or a heart shaped diamond, from the pavilion (Bottom side) and the Crown (Top side) with the naked eye. Because of the specific facet cuts along the pavilion, it gives the appearance of a gemstone within another gemstone. These facets produce the visual effect of a heart shape diamond inside a round diamond and heart shaped diamond.

### SUMMARY

In the main aspect of the invention, a gemstone visually encompasses a heart shape design within. The invention uses a gemstone comprising an upper double crown table facet, a lower pavilion with a culet at its lower tip, a girdle separating and distinguishing the upper crown table facet from the pavilion, and girdle main facets around the girdle. In furtherance of the objective of the invention, there are a plurality of pavilion facets below the girdle facet comprising of lower girdle facets, the short half facets and pavilion main facets. The kite shaped pavilion main facets emerge upwardly from the culet. The short arms of the kite shaped facet meet at the culet and long arms meet at 1st points which are at a girdle depth ranging from 70 to 85% of the girdle depth. The short arms and long arms of each pavilion main facet meet at 2nd points at depths ranging from 80 to 96% of the girdle depth. The lower girdle facets, which are substantially triangular emerge downwardly from the girdle. Substantially triangular short half facets are faceted from the lower girdle facets along a cable joining the 1st points. The lower girdle and the corresponding short half facet have a common vertex at 2nd points, pointing towards the culet. Pairs of short half facets alternate the long arms of the pavilion main facets. The girdle facet angle is in the range of 30° to 60°. The 1st pavilion short half angles, are formed along a cable joining the 1st points. The 1st pavilion short half angles are 0.01° to 8° less than the girdle facet angle. The 2nd pavilion short half angles are formed along a cable joining the 2nd points of the pavilion main facets, such that the 2nd pavilion short half angle is 0.01° to 8° less than the 1st pavilion short half angle. In a table view or pavilion view, the pavilion facets all appear to be arranged around the central culet on either side of an axis line along the horizontal plane.

In a further aspect of the invention, the gemstone is round, with the table facet comprising of 16 upper crown-1 facets, 16 upper crown-2 facets, 8 crown main facets and 8 star facets.

In another aspect of the invention the gemstone is heart shaped having a notch and an oppositely located apex. The table facet comprises of 16 upper crown-1 facets, 16 upper crown-2 facets, 9 crown main facets and 8 star facets.

In yet a further aspect of the invention the gemstone as has 4 to 12 pavilion main facets, and double the number of lower girdle facets and short half facets.

In an ideal aspect of the invention, the gemstone is a diamond and has 4 pairs of pavilion main facets and 8 pairs of short half facets and lower girdle facets, each facet being symmetrical with its corresponding facet pair across the axis line. The heart shaped gemstone has a girdle facet angle in the range of 43° to 48° at the girdle depth of 78% to 82% and the angle of variance between the 2nd pavilion short half angle at the 2nd point at a depth of 88.5% to 94% and the 1st pavilion short half angle in the range of 38° to 42° at 1st point at a depth of 82% to 85% is 0.3° to 5.0°. The angle variance between the girdle facet angle and the 1st pavilion short half angle is in the range of 1° to 7°. In a round gemstone, the girdle facet angle is in the range of 40° to 46° at the girdle depth of 78% to 82%. The angle variance between the 2nd pavilion short half angle at the 2nd point at a depth of 88.5% to 94% and 1st pavilion short half angle at 1st point at a depth of 82% to 85% is in the range of 0.5° to 5°. The angle variance between the girdle facet angle and the 1st pavilion short half angle is in the range of 1° to 5°.

In an interesting aspect of the invention, a pair of symmetrical short half facets having one common side along the axis line, have sides opposite the vertex meet at a facet depth approximately midway between the 1st point and the 2nd point relevant to the short half facet pair. A second pair of symmetrical short half facets also having one common side along the same axis line, have the second vertex at a common point on the cable and axis line, such vertex being at a girdle depth equivalent to the girdle depth of the 1st point of the longest pavilion main facet with a variance of not more than 15%.

Yet another aspect of the invention, relates to the method of making a gemstone encompassing the shape of a heart along the horizontal plane of the gemstone. The invention is worked on a gemstone with an upper double crown table facet, a lower pavilion with a culet at its tip, a girdle with girdle main facets, separating and distinguishing the pavilion from the crown table facet. The pavilion has pavilion facets with at least four pairs of lower girdle facets extending downwardly from the girdle to the culet, which in the table view or pavilion view appear to be arranged around the culet on either side of an axis line traversing the horizontal plane of the pavilion. In case of a heart shape diamond, the axis line passes through the notch and apex of the heart shape.

In the working aspect of this invention, the lower girdle facets are cut, chiselled and polished such that the lower girdle angle, at girdle depth of 65% to 85%, is in the range of 30° to 60°. The lower girdle facets are further cut and chiselled to have at least two pairs of symmetrical kite shaped pavilion main facets with a pair of short arms and long arms, such that the short arms meet at the culet, long arms meet at 1st points at a facet depth in the range of 70% to 85%, and the short arm and the long arm meet at 2nd points at facets depth in the range of 80% to 96%. The common vertices of adjacent pairs of the lower girdle facets are at the girdle depth of the 2nd points, after the pavilion main facets are cut. A pair of pavilion main facets, not having a common side along the axis line are first cut such the girdle depth of the 1^{st} point of this pavilion main facet is 0.5% to 10% less than the other pavilion main facets. A pair of pavilion short half facets are cut and chiselled from a pair of lower girdle facets having a common side along the axis line, along the pavilion surface of the gemstone from a point along the axis line at a girdle depth equivalent to the pair of pavilion main facets having 1^{st} points with the least girdle depth, at 1^{st} pavilion angles along a cable connecting the 1^{st} points of the pavilion main facets flanking such pair of pavilion short half facets. The remainder lower girdle facets are further cut, chiselled and polished at 1^{st} pavilion angles along a cable connecting the 1st points of all pavilion main facets, to form substantially triangular short half facets, the 1^{st} pavilion angles being at least 0.01 to 8.0° less than the lower girdle angle. The lower girdle facet and the corresponding short half facets have a common vertex at the respective 2nd points. The pavilion main facets of the gemstone are further cut chiselled and polished along a cable joining the 2nd points to form 2nd pavilion short half angles, such that the 2nd pavilion short half angle is at least 0.01 to 8° less than the 1st pavilion short half angle. The gemstone may be round or heart shaped.

In an ideal aspect of the invention relating to the method of obtaining a perfect heart shape design within the gemstone, the gemstone is cut, chiselled and polished to have 4 symmetrical pairs of pavilion main facets, 8 pairs of symmetrical lower girdle facets and 8 pairs of symmetrical short half facets, each facet in symmetry with the corresponding facet on the opposite side of the axis line. The 1^{st} pavilion short half angles at 1st points with facet depth ranging from 80-84.5%, is 2° to 8.0° less than the lower girdle facet angle, and further the 2nd pavilion short half angle at a facet depth of 91% to 94% is 0.25° to 5° less than the 1st pavilion short half angle.

In the final aspect of this invention, a pair of symmetrical adjacent short half facets with a common side along the axis line are prior cut and polished to have sides opposite the vertex at the 2nd point converging at a girdle depth approximately midway between the 1st point and the 2nd point.

This forms a heart shape design with notch and apex as seen from the table view or pavilion view.

### DESCRIPTION

### Drawings

FIG. 1: The round cut gemstone side view.

FIG. 2: Table view of round cut gemstone

FIG. 2 a: Crown top side angle view of round cut gemstone

FIG. 3: Pavilion view of round cut gemstone

FIG. 4: Exploded view of Pavilion Main facets of round cut gemstone.

FIG. 5: Pavilion angles in side view of a round cut gemstone

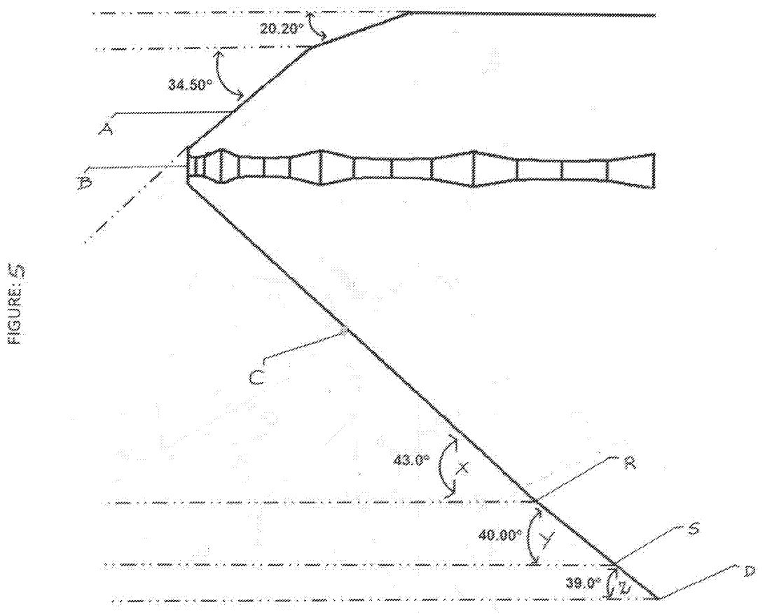

FIG. 6: angles in pavilion view.

FIG. 6a: girdle depth of 1st and 2nd Point on Pavilion of round cut gemstone

FIG. 7: table view of round gemstone, showing heart shape in the centre.

FIG. 8: The heart shaped gemstone side view.

FIG. 9: Table view of heart shaped gemstone

FIG. 9a: Crown top side angle view

FIG. 10: Pavilion view

FIG. 11: Exploded view of Pavilion Main facets

FIG. 12: Pavilion angles in side view of a round cut gemstone

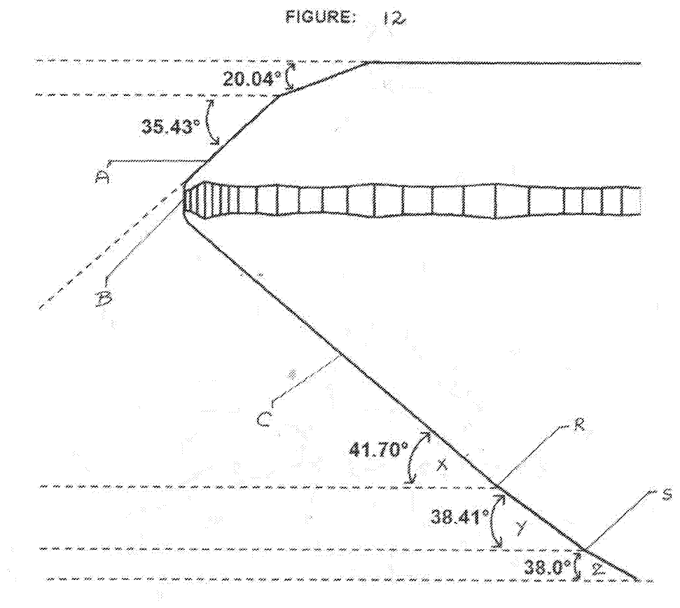

FIG. 13: angle variations of adjacent facets in heart shaped diamond.

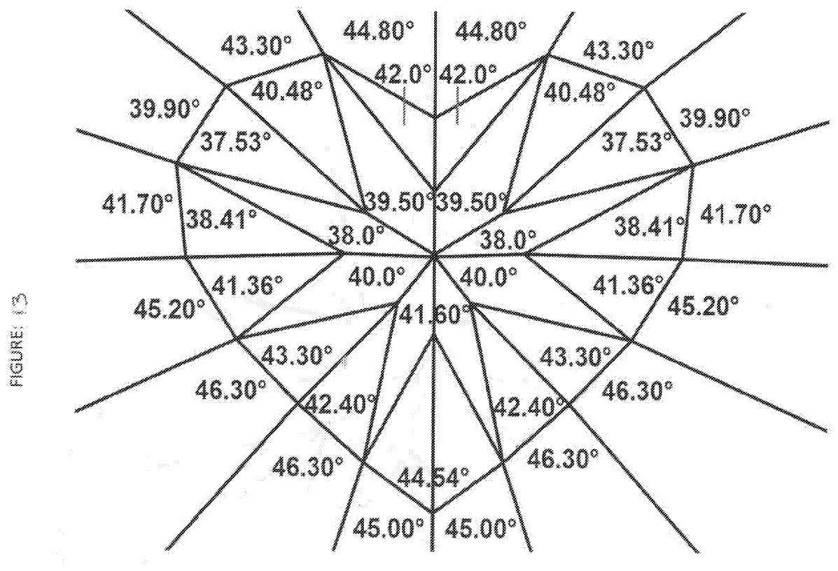

FIG. 14: girdle depth of 1st and 2nd Point on Pavilion.

FIG. 15: table view of round gemstone, showing heart shape in the centre.

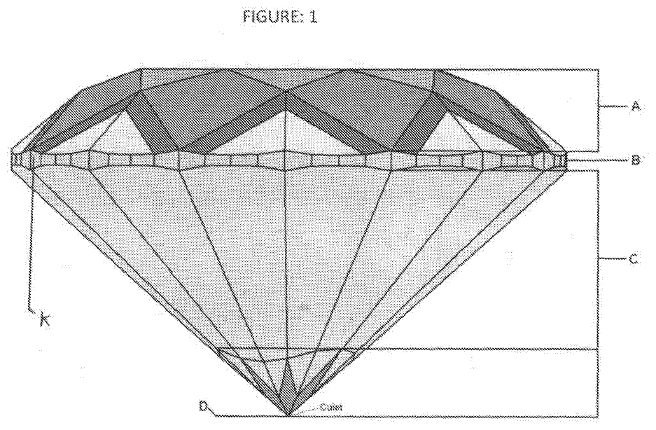

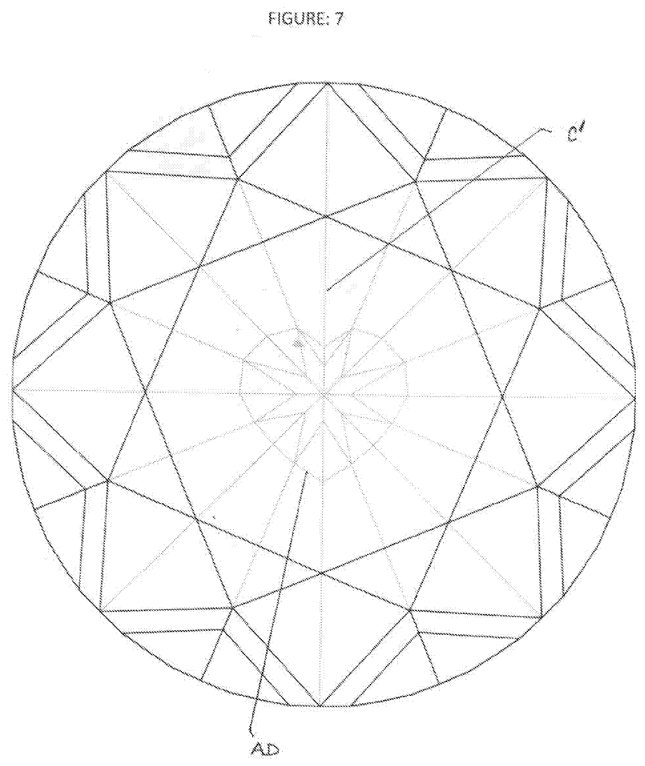

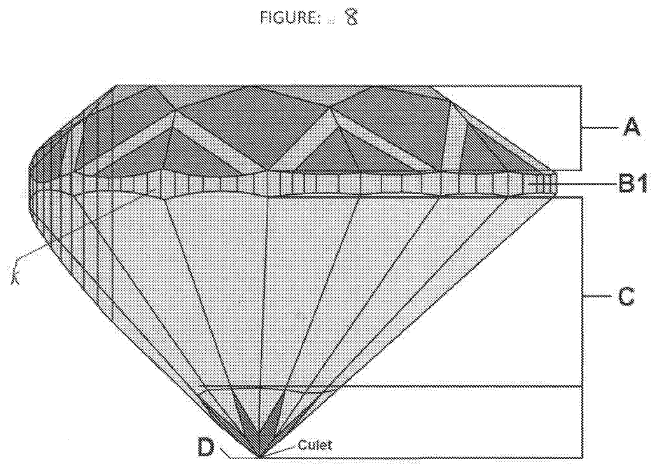

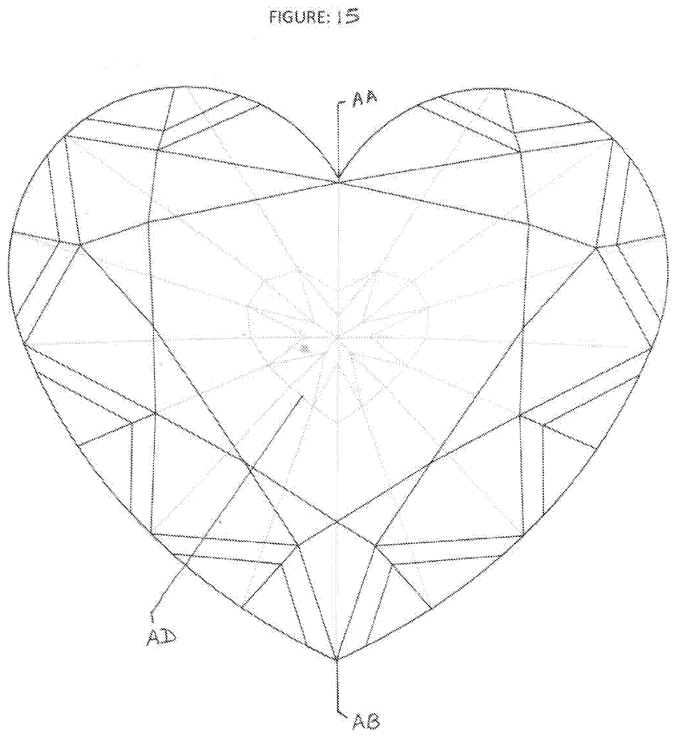

In its main embodiment the invention describes a uniquely cut double crown gemstone preferably round cut (FIG. 1) or heart shaped (FIG. 8) which visually encompasses a heart shape within (AD at FIG. 7, 15). The round or heart shaped gemstone of the present description, as commonly available in commerce, as seen in its side view (FIG. 1 and FIG. 8) is divided in to 3 regions: i. The upper face which is referred to as the upper double crown table facet (A). ii. The girdle (B) which is the region below the crown table facet iii. The pavilion (C) which is the lower part of the gemstone, i.e. the region below the girdle. The girdle separates and distinguishes the crown table facet from the pavilion. The lower most pointed tip of the pavilion is referred to as the culet (D). The arrangement of pavilion facets is around the culet (D) and an axis line (C′) that traverses the pavilion on the horizontal plane.

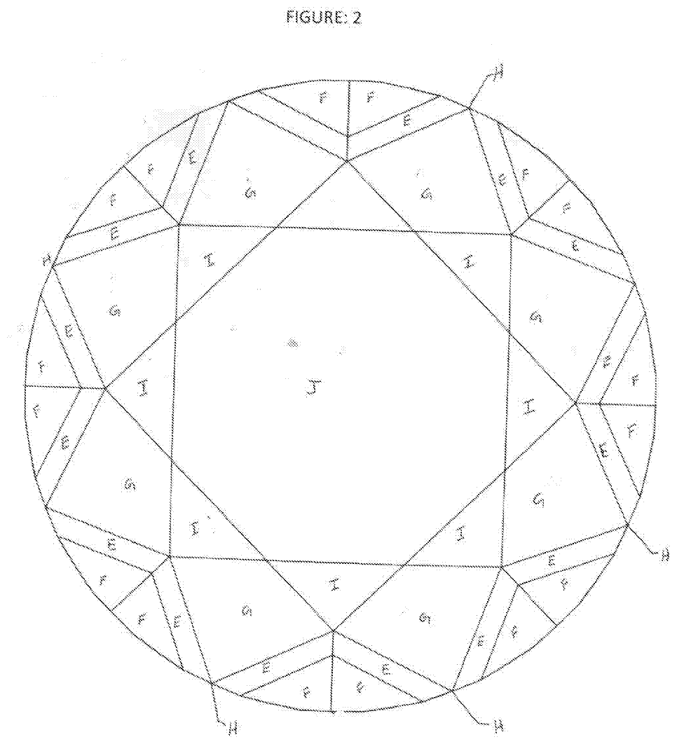

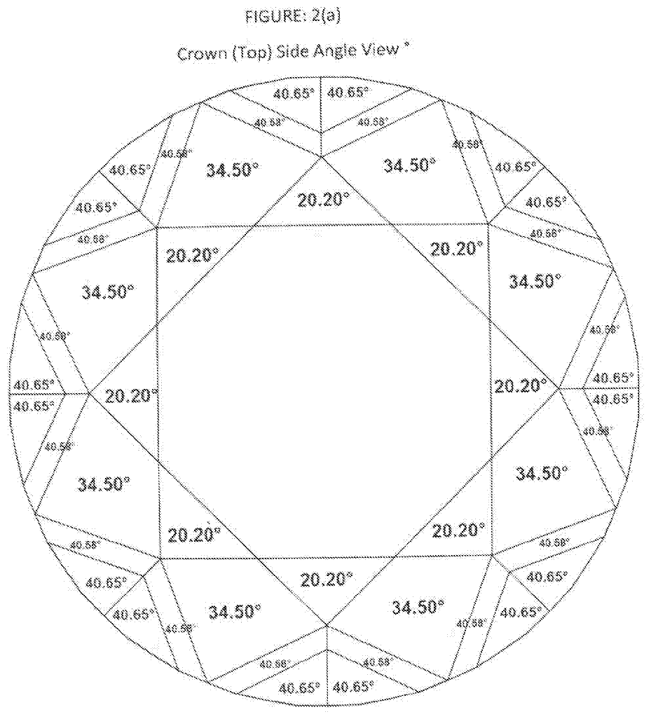

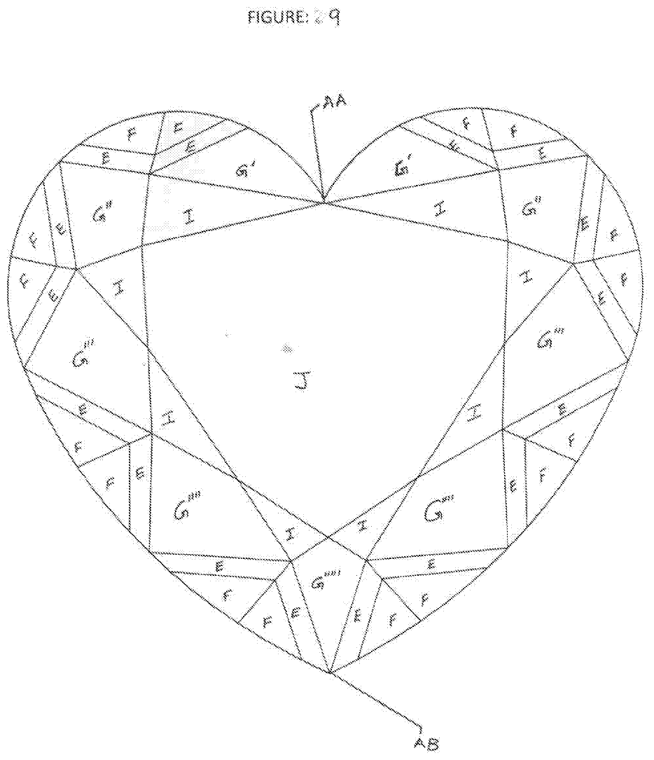

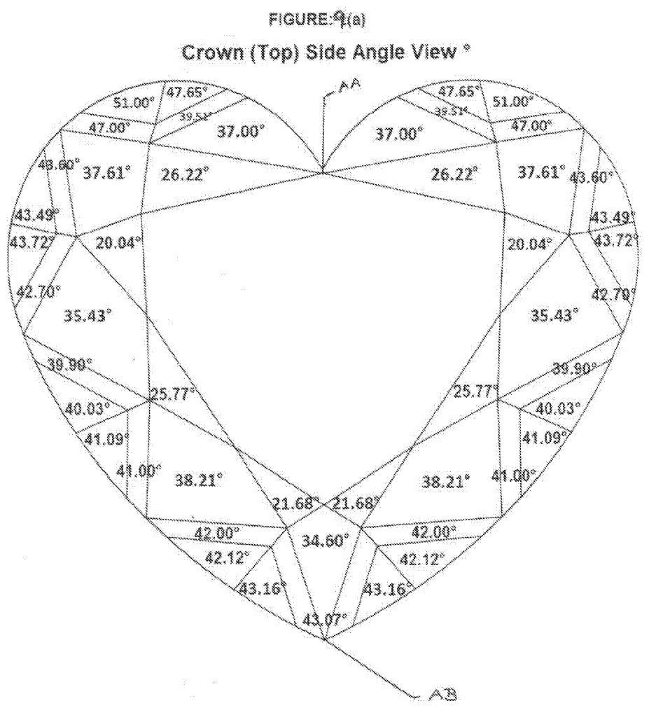

As seen in FIG. 2 & FIG. 9, the upper double crown table facet is comprised of a plurality of substantially trapezoid shaped Upper crown-1 facets (E), an equal number of substantially triangular shaped Upper crown-2 facets (F), kite shaped Main crown facets (G) where the long arms of the kite meet on the circumference (H) of the gemstone and triangular shaped star facets (I); The polygonal central table (J) at the centre is bordered on all sides by the star facets. There may be one or more girdle main facets (K) around the girdle. (FIGS. 1& 8)

The crown angles on the upper double crown table are at recommended angles as seen in FIGS. 2(a) and 9(a). The crown facet angles are usually in the range as seen in Table 1 below:

TABLE 1

| | Number | | Ideal angle | Ideal angle |
|---|---|---|---|---|
| | of | Angle | For round | range for |
| Name of facet | facets | range | cut | Heart shape |
| E1 to E16 | 16 | 35-48° | 40.00° | 40° |
| Upper crown-1 | | | | |
| F1 to F16 | 16 | 35-48 | 39.° | 39° |
| Upper crown-2 | | | | |
| G1 to G8 | 8 | 15-45° | 35.00° | As below |
| Crown main | | | | |
| Crown curve G′ | 2 | 30° to 38° | NA | 35° |
| Crown head-1 G′′ | 2 | 32° to 40° | NA | 36.50° |
| Crown head-2 G′′′ | 2 | 32° to 42° | NA | 37.00° |
| Crown wing G′′′′ | 2 | 33° to 40° | NA | 37° |
| Crown point G′′′′′ | 1 | 30° to 42° | NA | 34.50° |
| I-1 TO I-8 | 8 | 15-30° | 20° | 22° |
| Star facets | | | | |

The crown angles are determined by viewing the diamond from a side profile and visually estimating the angle of the top portion of the diamond. In respect of a round diamond, the upper crown-1 angle cut is in the range of 35° to 48° and the respective preferred azimuth edge of the upper crown-1 facets are 11.25°, 33.75°, 56.25°, 78.75°, 101.25°, 123.75°, 146.25°, 168.75°, 191.25°, 213.75°, 236.25°, 258.75°, 281.25°, 303.75°, 326.25°, 348.51°. The Upper Crown 2 facets are at an angle in the range of 35° to 48°. Upper Crown 2 facets are optional. Upper Crown 2 facets add more brightness to the stone. The Main crown facets are at an angle of 30° to 38° in relation to the upper crown 1 facet and the star facets are placed at 15° to 30.° in relation to the central table. In respect of a heart shape diamond, the upper crown-1 angle cut is in the range of 35° to 48° and the preferred azimuth edge of the upper crown-1 facets are 6.5°, 29°, 41.5°, 52.5°, 63.10°, 116.9°, 127.4°, 138.5°, 151°, 173.5°, 207.5°, 245.7°, 267.4°, 272.6°, 294.2°, 332.4° respectively. The Upper Crown 2 facets are at an angle in the range of 35° to 48°. and the preferred azimuth edge of the upper crown-2 facets are 6.59°, 28.89°, 41.55°, 52.49°, 63.19°, 116.79°, 127.49°, 138.43°, 151.00°, 173.39°, 207.59°, 244.90°, 267.99°, 271.99°, 294.99°, 332.39° respectively, Upper Crown 2 facets are optional. Upper Crown 2 facets add more brightness to the stone. The Main crown facets comprise of a pair of substantially triangular crown curve facet (G′) at an angle of 30 to 38° at an azimuth edge of 25° & 155.0°; a pair of four sided crown head-1 facet (G″) and a pair of four sided crown head-2 facet (G′″) at an angle of 32 to 40° at an azimuth edge of 233°, 256°, 284°, 307°; a pair of four sided crown wing facet (G″″) at an angle of 33° to 40° and at a preferred azimuth edge of 47° & 133°, and one kite shaped crown point facet (G′″″) at an angle of 30° to 42° in relation to the central table at 15° to 30.° in relation to the central table (J) at an azimuth edge of 36.45°, 61.78°, 118.20°, 143.54°, 192.85°, 256.33°, 283.65°, 347.13°. No claim is being made in respect of the crown angles or the crown table.

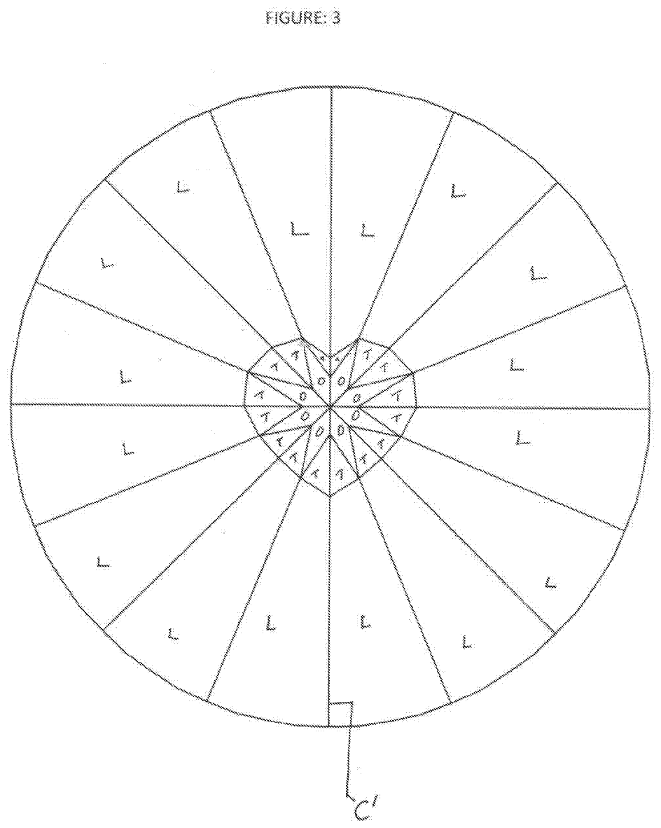

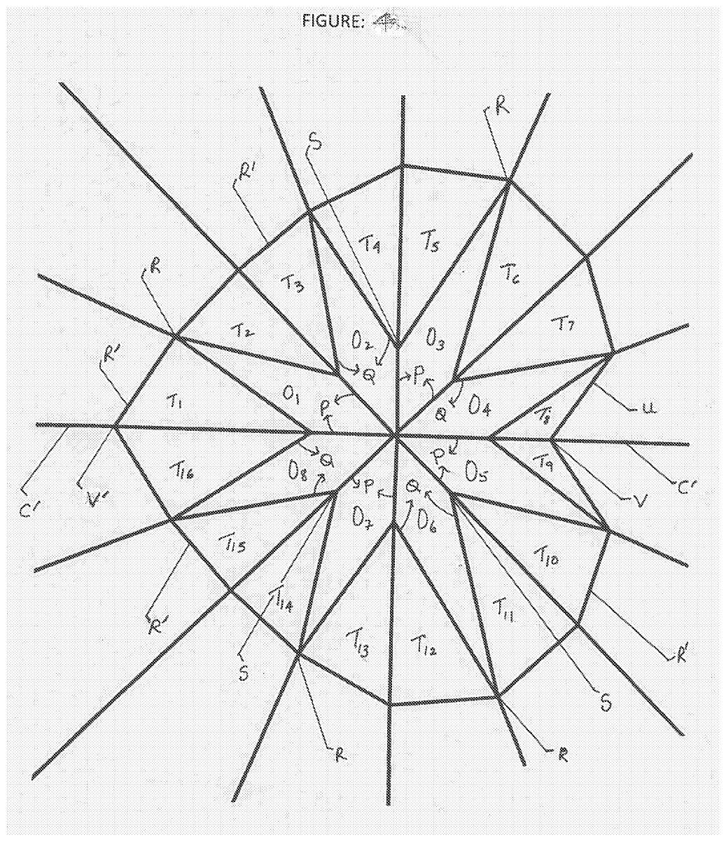

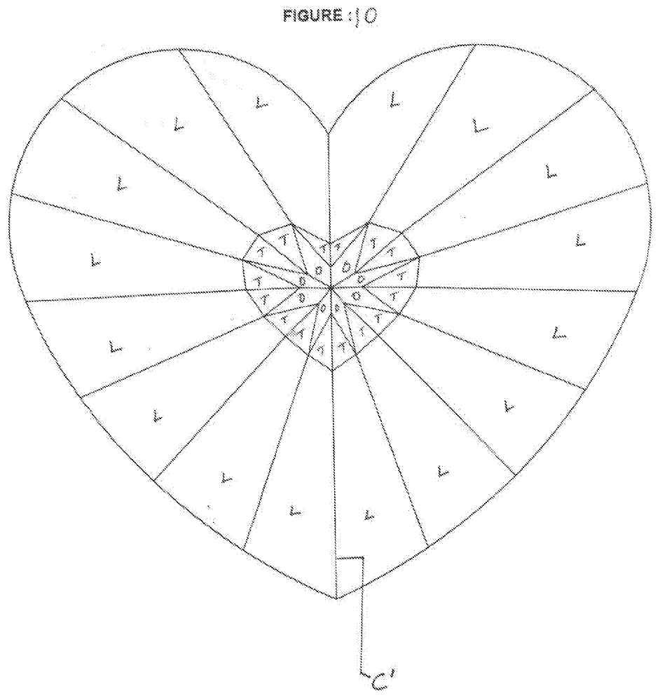

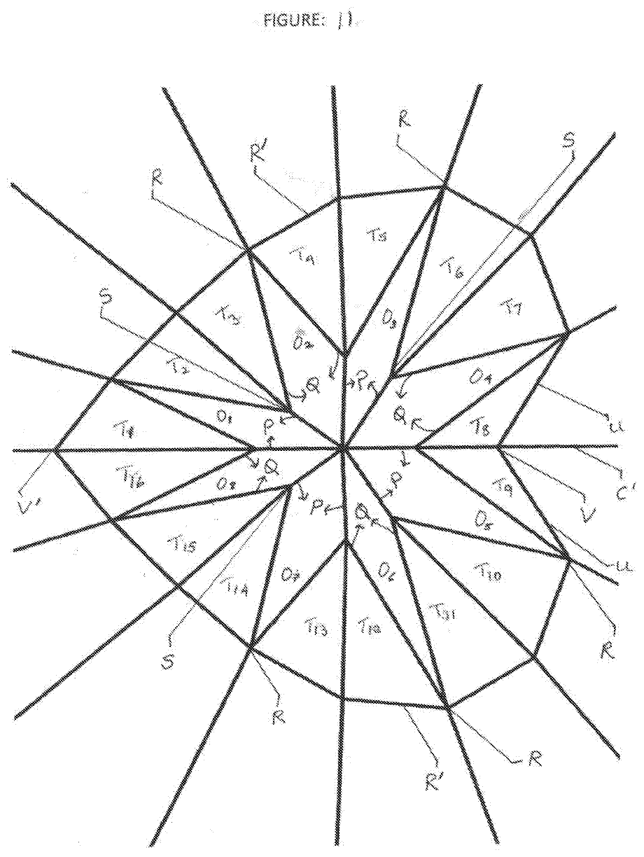

As seen in FIG. 3 and FIG. 10, the plurality of pavilion facets, which lye below the girdle facets (K), comprise of even number of lower girdle facets (L) and short half facets (T), and half the number of pavilion main facets (O). In a normal round cut or heart shaped gemstone, substantially triangular and even number of lower girdle facets (L) with girdle facet angles (X) in the range of 30° to 65° at girdle depths ranging from 65% to 85%, which extend downwards from the girdle having vertices towards the culet (D), are first cut and polished at heights and azimuth in the manner known in the art. In a primary embodiment of this invention, the lower girdle facets are cut and chiselled at azimuths such that kite shaped pavilion main facets (O) emerge upwardly of the culet. The short arms (P) of the kite shaped pavilion main facets converge at the culet and the long arms (Q) converge at 1^{st} points (R) which are approximately at a girdle depth of 70% to 85%. The long arm and short arm of each of the kite shaped pavilion main facets meet at 2^{nd} point(S) which are approximately at a girdle depth of 80 to 96%. Once the pavilion main facets are chiselled, the vertices of the lower girdle facets come to be at the girdle depth of the 2^{nd} point (S). The facets are cut and polished in the aforesaid order and arranged on either side of an axis plane traversing the pavilion along a horizontal plane. As seen at FIGS. 4 and 11, each pavilion facet has a corresponding symmetrical pavilion facet across the axis line, and the pavilion facets have one vertex pointing towards the culet. For the purpose of this embodiment a pair of symmetrical pavilion main facets (O₃,O₆) are cut from two pairs of lower girdle facets which do not have any common side along the axis line, and chiselled to have the 1^{st} point (R) of such pavilion main facet to be 0.5% to 10% less than the other pavilion main facets, thus making this pair the longest pavilion main facet. A pair of substantially triangular pavilion short half facets (T₈, T₉) are cut and chiselled from a pair of lower girdle facets having a common side along the axis line (C), at 1^{st} pavilion short half angles along a cable ‘R’ joining the 1^{st} points of the pavilion facets (O₄,O₅) nesting such short half facets. From a point (V′) where the axis line emerges to the pavilion surface, at a girdle depth equal to the girdle depth of the longest pavilion main facet with a variance of not more than 15%, the gemstone is cut, chiselled and polished along a cable (R′) at 1^{st} pavilion angles to connect the 1^{st} point of the pavilion main facets (O₁,O₈) adjacent to such pavilion short half facets (T₁, T₁₆). Subsequently substantially triangular short half facets (T) are faceted out from the remainder lower girdle facets, at 1^{st} pavilion short half angles, along the cable (R′) connecting the 1^{st} points of the remainder pavilion main facets, such that the lower girdle facets and corresponding short half facets have a common vertex at corresponding 2^{nd} points(S). In an optional embodiment of this invention, prior to cutting any pair of pavilion short half facets, a pair of small pavilion short half facets (T₈, T₉) are cut and chiselled from the culet end side of a pair of lower girdle facets having a common side along the axis line, at 1^{st} pavilion short half angles, along a cable (R). The cable (R′) connects the 1^{st} points of pavilion main facets (O₄,O₅) adjacent to such small pavilion short half facets (T₈, T₉), such that the cable traverses through a point (V) on the axis line at the azimuth of approximately 160° to 220°,at a girdle depth midway between the 1^{st} point and 2^{nd} point of the pavilion main facets (O₄,O₅) nesting such pair of small pavilion short half facets (T₈,T₉). This creates the indent to give a perfect notch and apex of the heart (AD) when the gemstone is seen from the pavilion view or the table view.

In a pavilion view, (FIGS. 3,4, 10,11) pairs of short half facets alternate the long arms of the pavilion main facets. The 1^{st} pavilion short half angles (W) are at least 0.05° to 8° less than the girdle facet angle (X). The pavilion main facets are further cut, chiselled and polished at a depth of the 2^{nd} points (S) at 2^{nd} pavilion short half angles along a 2^{nd} cable joining the 2^{nd} points of the pavilion main facets. The 2^{nd} pavilion short half angles are 0.25° to 5° less than the 1^{st} pavilion short half angles. This also results in the girdle depth of the culet being altered to a girdle depth less than the original gemstone. The pavilion main facets, short half facets, 1^{st} pavilion short angles and 2^{nd} pavilion short angles are cut, chiselled and polished at predetermined heights, facet angles, and azimuth to enable the invention.

In another embodiment of this invention, the gemstone has in addition to the table facet as described above, 12 to 24 lower girdle facets, 12 to 24 short half facets and 4 to 12 pavilion main facets.

The preferred facet azimuths for the girdle facets, 1^{st} pavilion short half angle and 2^{nd} pavilion short half angle for a round cut diamond, for an improved embodiment having 16 lower girdle facets, 16 short half facets and 8 pavilion main facets, with the 1st point of the pair of pavilion main facets (O₃,O₆) having the shortest girdle depth immediately adjacent to the pavilion mains (O₄,O₅) nestling the small pavilion short half facets. is given in Table II below:

TABLE II

| | | | Difference | |
|---|---|---|---|---|
| | | | from Its | |
| Name | | Number | Ideal | |
| of | Facets | of | Range(Plus | Ideal Facets |
| facet | involved | facets | or Minus) | Azimuth (Respectively) |
| Lower | M1 To | 8 | 0-15 | 11.25°; 33.75°; 56.25°; 78.75°; |
| Girdle | M16 | | | 101.25°; 123.75° |
| Facets | | | | 146.25°; 168.75°; 191.25°; |
| | | | | 213.75°; 236.25°; 258.75°; |
| | | | | 281.25°; 303.75°; 326.25°; |
| | | | | 348.75° |
| l^{st} Pavilion | T1 To | 16 | 0-15 | 211.08°; 33.65°; 56.31°; |
| (Short) | T16 | | | 78.88°; |
| Halves | | | | 101.32°; 123.75° |
| Angle | | | | 146.04°; 168.95°; 192.04°; |
| (Facets) | | | | 213.95°; 236.24°; 258.67°; |
| | | | | 281.11°; 303.68°; 326.34°; |
| | | | | 348.91° |
| Pavilion | O1 TO | 8 | 0-5 | 20.36°; 68.74°; 111.68°; |
| Mains | O8 | | | 158.71°; 201.28°; 248.31°; |
| Angle | | | | 291.25°; 339.63° |

The preferred facet azimuths for the girdle facets, 1^{st} pavilion short half angle and 2^{nd} pavilion short half angle for an improved embodiment having 16 lower girdle facets, 16 short half facets and 8 pavilion main facets, with the 1st point of the pair of pavilion main facets (O₃,O₆) having the shortest girdle depth immediately adjacent to the pavilion mains (O₄,O₅) nestling the small pavilion short half facets. for a heart shape diamond is given in Table III below

TABLE III

| | | | Difference | |
|---|---|---|---|---|
| | | | from Its | |
| Name | | Number | Ideal | |
| of | Facets | of | Range(Plus | Ideal Facets |
| facet | involved | facets | or Minus) | Azimuth (Respectively) |
| Lower | L1 To | 16 | 0-15 | 8.79°, 31.79°, 40.29°, 51.79°, |
| Girdle | L16 | | | 63.39°, 116.59°, 128.19°, |
| Facets | | | | 139.69°, 148.19°, 171.19°, |
| | | | | 209.29°, 245.89°, 257.09°, |
| | | | | 282.89°, 294.09°, 330.69° |
| l^{st} Pavilion | T1 To | 16 | 0-15 | 8.57°, 31.17°, 39.39°, |
| (Short) | T16 | | | 52.14°, 64.26°, 115.73°, |
| Halves Angle | | | | 127.84°, 140.6°, 148.810, |
| (Facets) | | | | 171.41°, 209.69°, 246.05°, |
| | | | | 252.07°, 287.92°, 293.94°, |
| | | | | 330.1° |
| Pavilion | O1 TO | 8 | 0-5 | 350.29°35.35°, 57.54°, |
| Mains | O8 | | | 122.47°, 144.66°, 189.73°, |
| Angle | | | | 249.52°, 290.5° |

The facet azimuths mentioned in the table are indicative of the preferred azimuth, and could vary in the range of +/−15°.

As seen in FIGS. (4) and (11), the pavilion facets (L, T, O) are symmetrical with the corresponding pavilion facets on the other side of the axis line (C′).

In round cut gemstone, there is a consistency in the girdle angles, 1st pavilion short half angles and 2nd pavilion short half angles, subject to minor variations in the range of +/−1°. In respect of heart shaped gemstones, the facets are further cut, chiselled and polished such that there is a variation in the girdle facet angles of adjacent lower girdle facets in the range of 0° to 2°. Likewise there is a variation in the 1^{st} pavilion short half facet angles of adjacent short half facets in the range of 0° to 3.5°, and in 2^{nd} pavilion short half facet angles in the range of 0° to 3°. This addresses the asymmetry in a heart shaped gemstone, to enable the making of a gemstone encompassing a heart shape within. Table IV below gives the angle range of the girdle facet angle, 1st pavilion short half angle and 2nd pavilion short half angle, which would enable a heart shaped design to be produced within the gemstone.

TABLE IV

| | | | | | IDEAL |
|---|---|---|---|---|---|
| | | IDEAL | | IDEAL | ANGLE |
| Name | No. OF | FACET | ANGLE | ANGLE For | range For |
| OF Angle | FACETS | NO. | RANGE | round cut | Heart shape |
| Girdle facet | 8-24 | 16 | 30-60 | 43.0° | 39.90° to |
| angle | | | | | 46.30° |
| 1^{st} pavilion | 8-24 | 16 | 30-60 | 39.5° | 37.53° to |
| short half | | | | | 44.54° |
| angle | | | | | |
| 2^{nd} pavilion | 4-12 | 8 | 25-45 | 36.0° | 38° to 41.60° |
| short half | | | | | |
| angle | | | | | |
| Difference in | *** | | 0.01°- | 3.0° | +0.46° to |
| girdle facet | | | 8.0° | | +3.90° |
| angle & | | | | | |
| 1^{st} pavilion | | | | | |
| short half | | | | | |
| angle | | | | | |
| Difference in | ** | * | −4.00° | 1.0° | −3.30° To |
| 1^{st} pavilion | | | to 8° | | +0.47° |
| short half | | | | | |
| angle and | | | | | |
| 2^{nd} pavilion | | | | | |
| short half | | | | | |
| angle | | | | | |

Table V below gives the percentage depth at which the lower girdle facets, short half facets and pavilion main facets, the 1^{st} pavilion short half angle and the 2^{nd} pavilion short lower half angle with reference to the girdle are cut, where girdle is considered as 0 and culet as 100.

| | Short | | | |
|---|---|---|---|---|
| | Names of | Number | Ideal Girdle | Range of |
| Name of facet | Facets | of facet | Depth | Girdle Depth |
| Lower (Halves) Girdle | M1 To | 16 | 65 to 85 | 78 to 82 |
| Facets (Pavilion Lower | M16 | | | |
| Halves Facets) | | | | |
| 1^{ST} Pavilion(Short) Halves | T1 To | 16 | 70 to 85 | 82 to 85 |
| Angle (Facets) | T16 | | | |
| 2^{nd} Pavilion Angle | O1 To | 8 | 80 to 96 | 88.5 to 96 |
| | O8 | | | |

In a more precise embodiment of the invention, the gemstone has 16 lower girdle facets, 16 short half facets and 8 pavilion main facets and the facet depth at the 1^{st} point ranges from 82-85%, and the facet depth at the 2^{nd} point ranges from 88.5 to 96%, with angles of variance among the facets as mentioned above.

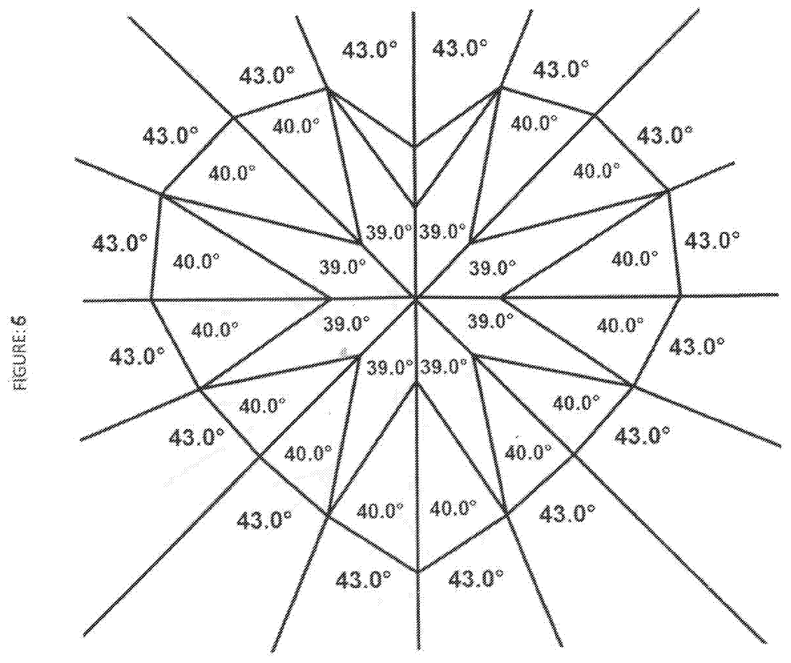

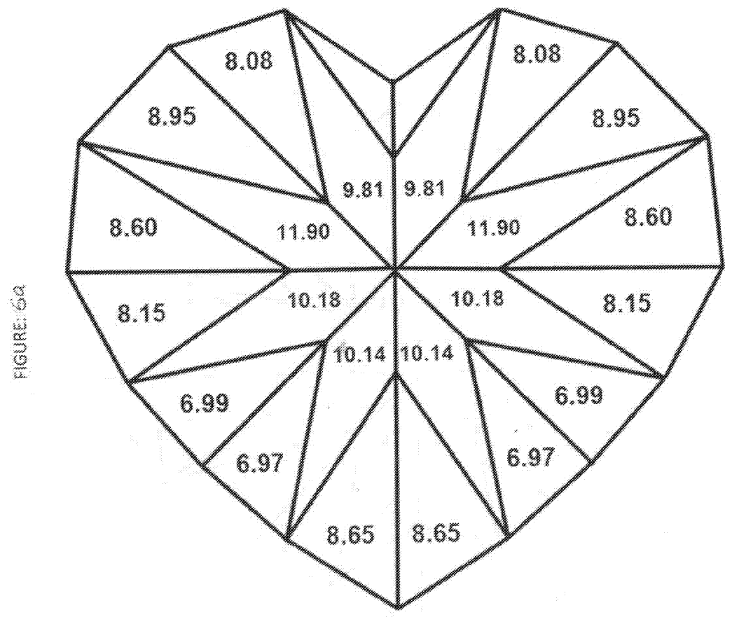

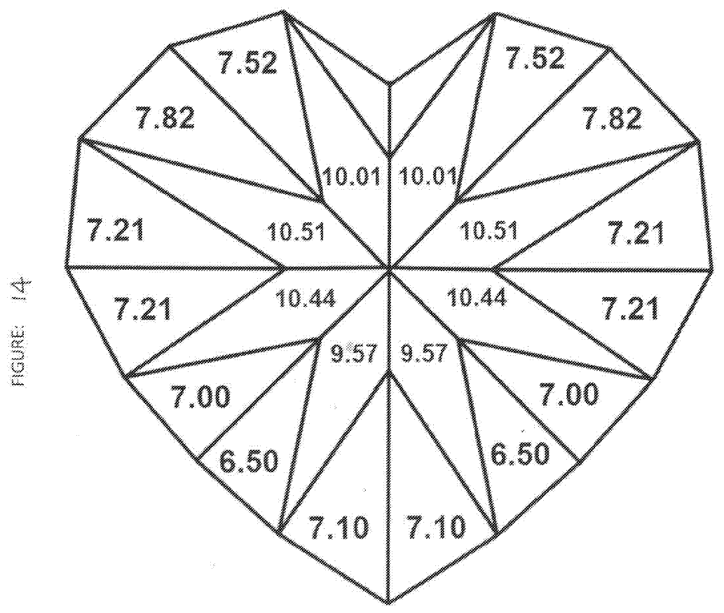

FIG. 6a and FIG. 14 depict representations showing girdle depth at which desired results of a perfect heart shape is achieved in a round cut gemstone and heart shape gemstone respectively.

This invention could be applied to any gemstone where the hardness is over 5, but it is best applied in a diamond, where because of the brightness, lustre and fire, as a result of the cuts on the table facet, the heart shape is perfectly seen inside the diamond, giving the effect of one diamond being inset in another diamond.

1. A gemstone visually encompassing a heart shape within, comprising an upper double crown table facet having a plurality of upper crown-1 facets, equal number of upper crown-2 facets, approximately half the number of crown main facets and half the number of star facets as upper crown-1 facet, the star facets bordering a central-table facet; a lower pavilion with a culet at its lower tip, a girdle separating and distinguishing the upper crown table facet from the pavilion, girdle main facets around the girdle, the pavilion having:
i. a plurality of pavilion facets below the girdle facet appearing to be arranged on either side of an axis line traversing the pavilion along a horizontal plane comprising of kite shaped pavilion main facets emerging upwardly from the culet having short arms meeting at the culet and long arms meeting at first points at a girdle depth ranging to −70 to 85%, and the short arms and long arms of each pavilion main facet meeting at second point at a girdle depth ranging from 80 to 96%, even number of substantially triangular lower girdle facets emerging downwardly from the girdle, pairs of substantially triangular short half facets with a common side, faceted from the lower girdle facets along a cable joining the first points, the lower girdle facet and the corresponding short half facet having a first common vertex at second points, pointing towards the culet, the pairs of short half facets alternating the long arms of the pavilion main facets;
ii. a girdle facet angle in the range of 30° to 60°, first pavilion short half angles, along a cable joining the first points being 0.01° to 8° less than the girdle facet angle, and second pavilion short half angles along a cable joining the second points of the pavilion main facets, such that the second pavilion short half angle is 0.01° to 8° less than the first pavilion short half angle;
iii. the pavilion facets symmetrical to the corresponding pavilion facets across the axis line;
iv. one of the two pairs of symmetrical short half facets having a common side along the axis line, being smaller than the other, and each of the pairs having a common vertex at a point where the axis line intersects the cable;
v. and the girdle depth of the first point of one pair of symmetrical pavilion main facets, and the girdle depth of the cable where it passes through the common vertex of the larger of the pair of short half facets is approximately the same with a variance of not more than 15%.

2. The gemstone as claimed in claim 1, which is round, with the upper double crown table facet comprising of sixteen upper crown-1 facets, sixteen upper crown-2 facets, eight crown main facets and eight star facets.

3. The gemstone as claimed in claim 1, which is heart shaped having a notch and an oppositely located apex, and the axis line passing through the apex and the notch, and the upper double crown table facet comprising of sixteen upper crown-1 facets, sixteen upper crown-2 facets, nine crown main facets and eight star facets.

4. The gemstone as claimed in claim 3 wherein the crown main facets, comprise of a pair of crown heart 1 facet, crown head 2 facet, crown curve facet and crown wing facet, and one crown point facet, all of which are symmetrical to the corresponding main facets across the axis line.

5. The gemstone as claimed in claim 2, wherein the gemstone has four to twelve pavilion main facets, and double the number of lower girdle facets and short half facets.

6. The gemstone as claimed in claim 4, wherein the gemstone has four to twelve pavilion main facets, and double the number of lower girdle facets and short half facets.

7. The heart shaped gemstone as claimed in claim 6, with the girdle facet angle in the range of 43° to 48°, the angle variance between the second pavilion short half angle and the first pavilion short half angle in the range of −38° to 42°, is −0.3° to 5.0°, and the angle variance between the first pavilion short half angles and the girdle facet angles being in the range of 1° to 7°.

8. The round gemstone as claimed in claim 5, with the girdle angle in the range of −40° to 46° and the angle variance between the second pavilion short half angle and first pavilion short half angle is in the range of 0.5° to 5°, and the angle variance between the first pavilion short half angles and the girdle facet angles being in the range of 1° to 5°.

9. The gemstone as claimed in claim 7, wherein the gemstone has four pairs of symmetrical pavilion main facets and double the number of pairs of symmetrical lower girdle facets and short half facets.

10. The gemstone as claimed in claim 9, with the smaller of the pair of symmetrical small short half facets having one common side along the axis line, having sides opposite the culet facing vertex meet at a girdle depth approximately midway between the first point and the second point of the pavilion main facets (O₄,O₅) nestling the small short half facets.

11. The gemstone as claimed in claim 10, wherein the first point of the pair of pavilion main facets having the shortest girdle depth is immediately adjacent to the pavilion mains nestling the small short half facets.

12. The gemstone as claimed in claim 11, where in the gemstone is a diamond.

13. A method of cutting a round cut gemstone to encompass the shape of a heart, from the gemstone having an upper double crown table facet, a lower pavilion with a culet at its tip and having an axis line along a horizontal plane, and a girdle separating and distinguishing the pavilion from the upper double crown table facet, the crown table facet having a plurality of upper crown-1 facets, equal number of upper crown-2 facets, and half the number of main crown facets and star facets, the star facets bordering a central-table face; girdle main facets around the girdle, with at least four pairs of lower girdle facets, extending downwardly from the girdle with vertices facing the culet at a lower girdle angle in the range of 30° to 60°, and arranged on either side of an axis line traversing the gemstone along a plane parallel to the table facet, cutting and polishing from pairs of lower girdle facets, half the number of pairs of symmetrical kite shaped pavilion main facets, each pavilion main facet having a pair of short arms meeting at the culet (D), long arms meeting at first points at girdle depths ranging from −70 to 85%, and the short arm and the long arm meeting at second points at girdle depths ranging from −80% to 96%, with the vertices of the lower girdle facets coming to be at the girdle depth of the second point, cutting and chiselling one pair of symmetrical pavilion main facets not having a common side along the axis line, to have a girdle depth at the first point to be less than the girdle depth of the remainder first points by 0.5% to 10%, optionally cutting and chiselling a pair of small pavilion short half facets from the culet end side of a pair of lower girdle facets having a common side along the axis line at first pavilion short half angle, along a cable connecting the first points of pavilion main facets adjacent to such lower girdle facets, such that the cable traverses through a point at a girdle depth midway between the first point and second point of the pavilion main facets nesting the pair of small pavilion short half facets so formed, further cutting and chiselling a second pair of lower girdle facets also having a common side along the axis line, at first pavilion short half angles from a point where the axis line emerges to the pavilion surface, at a girdle depth of the pavilion main facets having the least girdle depth with a variance of not more than 15%, along the cable, to the first points of the pavilion main facets adjacent to such lower girdle facets, forming a pair of pavilion short half facets, further cutting, chiselling and polishing the remainder lower girdle facets at first pavilion short half angles, along the cable connecting the first points, to form remaining pairs of pavilion short half facets with the common sides of each of the short half facets intersecting the cable such that pairs of pavilion short half facets are nested between the long arms of the pavilion main facets.

14. A method as claimed in claim 13 in which the first pavilion short half angles are cut and chiselled to be at least 0.01 to 8.0° less than the lower girdle angle, further cutting, chiselling and polishing the pavilion main facets along a cable joining the second points to form second pavilion short half angles, such that the second pavilion short half angle is at least 0.01° to 8° less than the first pavilion short half angle.

15. The method as claimed in claim 14, wherein the gemstone is cut, chiselled and polished to have four symmetrical pairs of pavilion main facets from eight pairs of symmetrical lower girdle facets and eight pairs of symmetrical short half facets, each facet in symmetry with the corresponding facet across the axis line, and the first pavilion short half angles being 2° to 8.0° less than the lower girdle facet angle, and further the second pavilion short half angle being 2 to 5° less than the first pavilion short half angle.

16. A method of cutting a symmetrically shaped heart shaped gemstone with a notch and an apex along an axis line on a horizontal plane, to encompass a heart shape design within, the gemstone having a plurality of upper crown-1 facets, equal number of upper crown-2 facets, half the number of star facets and half plus one number of crown main facets, the star facets bordering a central-table facet; a lower pavilion with a culet at the lower tip, a girdle separating and distinguishing the table facet from the pavilion, girdle main facets around the girdle, with at least four pairs of lower girdle facets arranged on either side of the axis line, and extending downwardly from the girdle with vertices facing the culet, at a lower girdle angle in the range of 30° to 60°, cutting and polishing from pairs of lower girdle facets, half the number of pairs of kite shaped pavilion main facets, emerging upwardly from the culet having a pair of short arms meeting at the culet and long arms, meeting at first points at a facet depth in the range of 70 to 85%, and the short arm and the long arm meet at second points at a depth of % to 96%, with the vertices of the lower girdle facets coming to be at the girdle depth of the second point, the pavilion main facets in symmetry with the corresponding pair across the axis line, such that the girdle depth of the first point of one pair of symmetrical pavilion main facets not having a common side along the axis line, is less than the girdle depth of the remainder first points by 0.5% to 10%, optionally cutting and chiselling a pair of small pavilion short half facets from the culet end side of a pair lower girdle facets having a common side along the axis line at first pavilion short half angle, along a cable connecting the first points of pavilion main facets adjacent to such lower girdle facets, which traverses through a point at a girdle depth midway between the first point and second point of the pavilion main facets nesting the pair of substantially triangle small pavilion short half facets so formed, further cutting and chiselling a second pair of lower girdle facets also having a common side along the axis line, at first pavilion short half angles from a point where the axis line emerges to the pavilion surface, at a girdle depth of the pavilion main facets having the least girdle depth with a variance of not more than 15%, along the cable, to the first points of the pavilion main facets adjacent to such lower girdle facets, forming a pair of substantially triangle pavilion short half facets, further cutting, chiselling and polishing the remainder lower girdle facets at first pavilion angles along a cable connecting the first points, to form remaining pairs of substantially triangle pavilion short half facets with the common sides of each of the short half facets intersecting the cable such that pairs of pavilion short half facets are nested between the long arms of the pavilion main facets.

17. A method as claimed in claim 16, wherein the first pavilion short half angles are cut and chiselled to be at least 0.01 to 8° less than the lower girdle facet angles, and, further cutting, chiselling and polishing the pavilion main facets at second pavilion short half angles along a cable, connecting the second points, such that the second pavilion angles are at least 0.01 to 8.00° less than the first pavilion angle.

18. The method as claimed in claim 17, wherein the gemstone is chiselled and cut to have eight pavilion main facets, sixteen lower girdle facets and sixteen short half facets and further cut and chiselled such that the first pavilion short half angles at first points with facet depth ranging from 80-84.5%, are 1° to 7° less than the lower girdle facet angle, and the second pavilion short half angle at a facet depth of 88.5% to 91% is 0.025° to 3° less than the first pavilion short half angle.

19. The method as claimed in claim 15 wherein the gemstone is a diamond.

20. The method as claimed in claim 18 wherein the gemstone is a diamond.
